(19) United States
(12) Patent Application Publication
(10) Pub. No.: US 2007/0110155 A1
(43) Pub. Date: May 17, 2007

(54) Method and apparatus of high efficiency image and video compression and display

(76) Inventors: Chih-Ta Star Sung, Glonn (DE); Yin-Chun Blue Lan, Wurih Township (TW)

Correspondence Address: Chih-Ta Star SUNG;RM. 308, BLD. 52, NO. 195, CHUNG HSING RD., SEC. 4, CHU TUNG TOWNSHIP, HSINCHU COUNTY, 310, TW

(21) Appl. No.: 11/273,571

(22) Filed: Nov. 15, 2005

(51) Int. Cl. H04N 11/04; H04N 7/12

(52) U.S. Cl. 375/240.13; 375/240.26

(57) ABSTRACT

A method and an apparatus of image and video compression, decoding and display procedure includes: image and video compression by taking the digitized one color per pixel format instead of RGB or YUV per pixel. Manipulation of video decompression and the color processing before being presented to the display device saves the density and I/O bandwidth of the storage device and transmission time. The digitized color components are compressed and stored in the referencing frame buffer and decompressed block by block before motion estimation.

### BACKGROUND OF THE INVENTION

1. Field of Invention

The present invention relates to the video compression and display techniques, and particularly relates to the video compression and display specifically for simplifying the compression procedure and reducing the requirements of image buffer size, I/O bandwidth and times of operation.

2. Description of Related Art

In the past decades, the semiconductor technology migration trend has driven the digital image and video compression and display feasible and created wide applications including digital still camera, digital video recorder, web camera, 3G mobile phone, VCD, DVD, Set-top-box, Digital TV, . . . etc.

Most commonly used video compression technology like the MPEG and JPEG take the procedure of image and video compression in the YUV (Y/Cr/Cb) pixel format which is from converting the digitized raw color data with one color component per pixel to three color components (Red, Green and Blue or so named RGB) per pixel and further converting to YUV as shown in the prior art procedure of image/video compression and display in FIG. 1. Most video compression algorithms require that the image sensor transfer the image pixels to a temporary image buffer for compression, under this kind mechanism, the pixel data amount shoots to three components from only one in the image sensor which requires quite a lot storage device density. And the data transferring from the image sensor to the temporary image buffer and back to the video compression engine causes delay time and requires high I/O bandwidth in data transferring and dissipates high power consumption.

This invention takes new alternatives and more efficiently overcomes the setbacks of prior art video and image compression with much less cost of semiconductor die area and chip/system packaging. With the invented method, an apparatus of integrating most image and video compression function with the image sensor becomes feasible.

### SUMMARY OF THE INVENTION

The present invention of the high efficiency video compression and decompression method and apparatus significantly reduces the requirement of I/O bandwidth, memory density and operation times by taking some innovative approaches and architecture in realizing a product.
The present invention of the high efficiency video compression and decompression directly takes raw image data output from the image sensor with one color component per pixel and compression the image frame data.
The present invention of the high efficiency video compression and decompression searches for the “best matching” position by calculating the SAD by using the raw pixel data in stead of the commonly used Y-component or so named “Luminance”.
According to an embodiment of the present invention of the high efficiency video compression and decompression, the procedure of color processing is done after decoding and before presenting to a display device.
According to an embodiment of the present invention of the high efficiency video compression and decompression, the minimized searching range is applied and a default range of allocating the raw image data from the image sensor is also minimized.
According to an embodiment of the present invention of the high efficiency video compression and decompression, an image compression unit is applied to reduce the data rate of the referencing frame buffer.
According to an embodiment of the present invention of the high efficiency video compression and decompression, when the video compression engine moves the first range of pixels from the referencing frame buffer to the searching buffer, when the predicted displace of the motion is beyond a threshold value, the 2^{nd} range of pixels will then be moved from the referencing frame buffer to the searching buffer.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1A depicts a prior art of video compression procedure.

FIG. 1B depicts a prior art of a video compression with detail of image sensor data conversion to a working format of Y-U-V pixel format.

FIG. 2 depicts a diagram of a basic video compression.

FIG. 3 illustrates the method of motion estimation for the best matching block searching.

FIG. 4 illustrates the procedure of the method of this invention of the high efficiency video compression.

FIG. 5 illustrates the diagram of this invention of the high efficiency video compression.

FIG. 6 shows the diagram of the motion estimation of this invention of the high efficiency video compression.

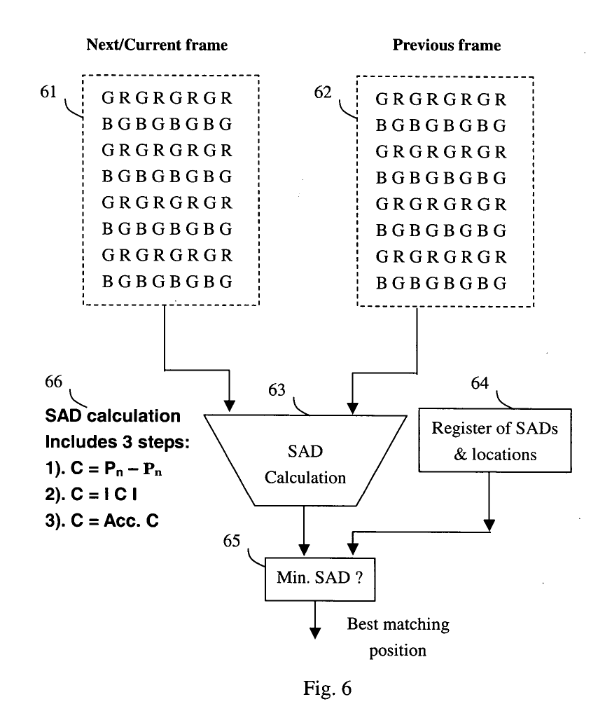

FIG. 7 illustrates the diagram of the block based video compression and decompression.

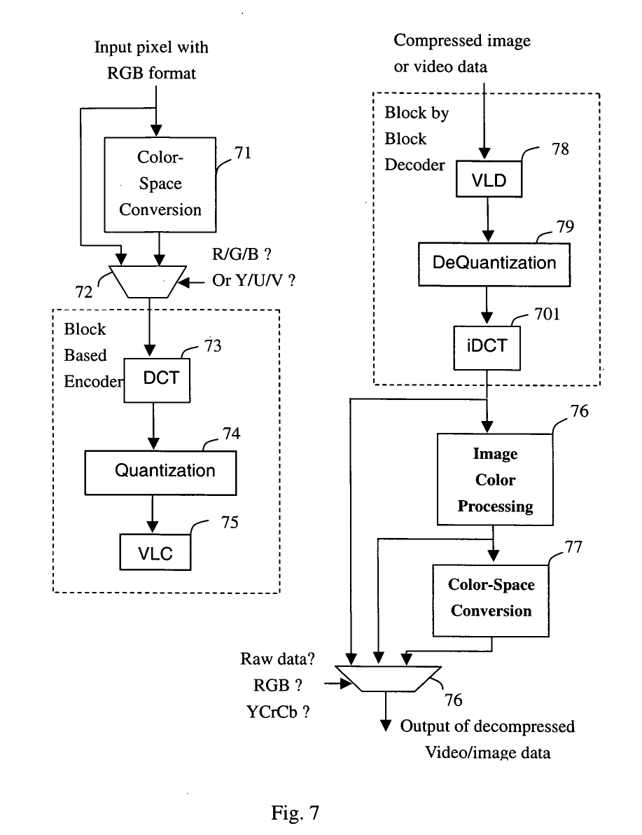

FIG. 8 depicts two types of allocating pixels from the referencing frame buffer to the searching range buffer during video compression.

FIG. 9 shows the diagram of this invention which include high efficient motion video compression unit and the still image compression unit.

### DESCRIPTION OF THE PREFERRED EMBODIMENTS

semiconductor technology migration trend has driven the digital image and video compression to be feasible and created wide applications including digital still camera, digital video recorder, web camera, 3G mobile phone, VCD, DVD, Set-top-box, Digital TV, . . . etc. Most electronic devices within an image related system include a semiconductor image sensor functioning as a image capturing device as shown. The image sensor can be a CCD or a CMOS image sensor. Most image and video compression algorithms, like JPEG and MPEG have been developed in late 1980s' or early 1990s'. The CMOS image sensor technology was not mature then. The CCD sensor has inheriting higher image quality than the CMOS image sensor and has been used in applications requires image quality like scanner, high-ended digital camera or camcorder or surveillance system or the video recording system. Image and video compression techniques are applied to reduce the data rate of the image or video stream. Compression is critical for saving the requirement of memory density, time and I/O bandwidth in transmission.

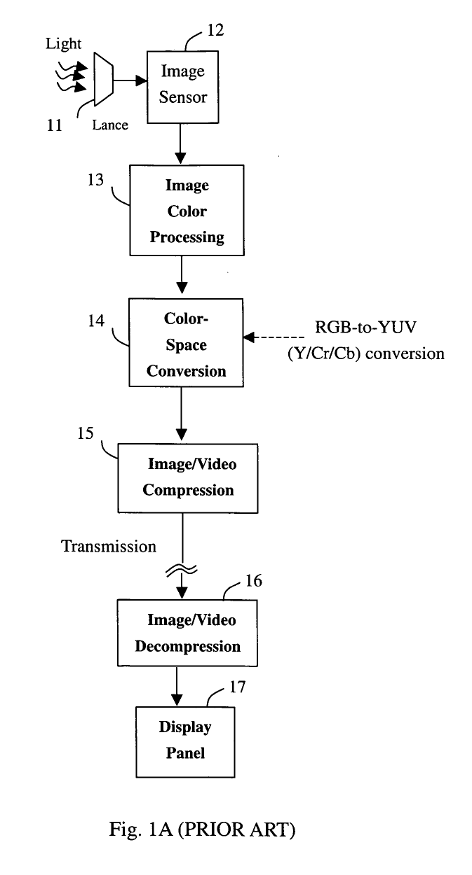

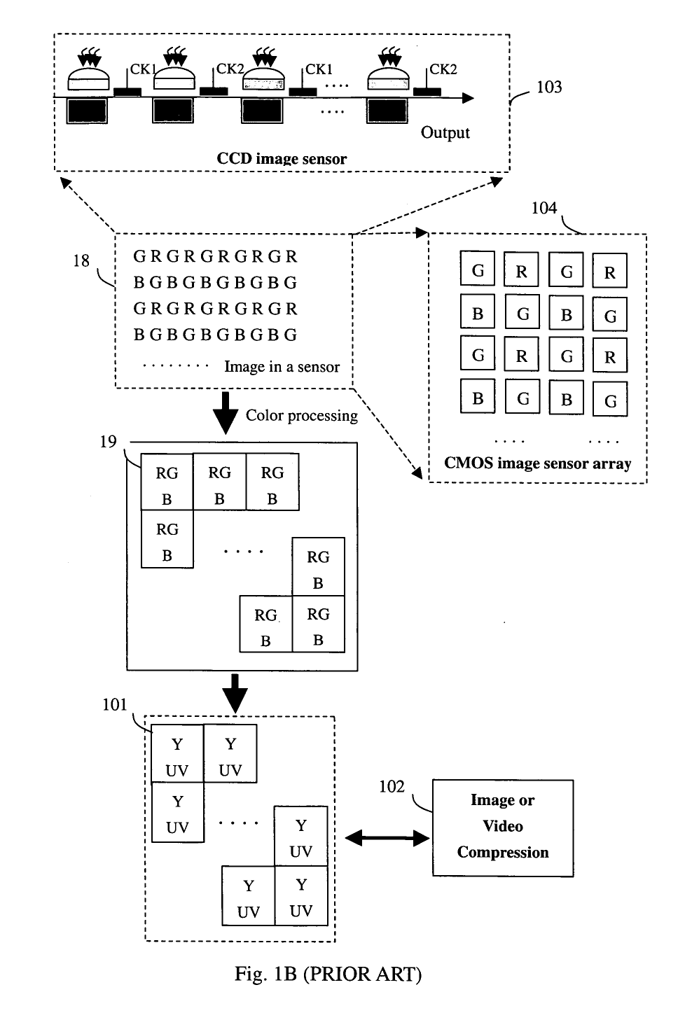

In the prior art image capturing and compression as shown in FIG. 1A, an image sensor 12 captures pixel information of the light shooting through a lens 11. The captured pixel signal stored in the image sensor is weak and needs procedure of signal processing before being digitized by an analog-to-digital converter, (or so called ADC) to an output format. The digitized pixel data has most likely one color component per pixel and will go through an image color processing 13 to convert to be three color components per pixel including Red, Green and Blue (R,G, B). The color processing procedure includes but not limited the following steps: white balance, gamma correction and color compensation. The later applies an interpolation method to calculate two neighboring color components to form three color components per pixel. The RGB pixels are then further converted to be YUV (and/or Y,Cr,Cb) format for video or image compression. Y, the Luma is the component representing the brightness, U and V (or Cr/Cb), Chroma, are the relative color components. Most image and video compression 15 takes YUV pixel format as the input pixel data to take advantage of human being's vision which is more sensitive to brightness than color and take more brightness data and less color components in compression. In the display point of view, a decompression procedure 16 recovers the pixel image of YUV/YCrCb and converts to RGB format with 3 color components per pixel and sends to the display device 17.

FIG. 1B details the procedure of the image capturing and compression. An image sensor 18 capturing an frame of image can be comprised of a CCD 103, charge coupled device, image sensor or a CMOS image sensor 104. A CCD sensor cell captures the light and transformed to be electronic charge is transformed serially to the output node by two non-overlapping clocks as marked CK1 and CK2. The CMOS image sensor is comprised of a sensor array 104 which can be randomly accessed by turning on the raw elect and column selection devices. Both outputs of the CCD and CMOS image sensors are connected to an Analog-to-digital-converter, ADC to digitize to a digital form with bit rate per pixel depending on the resolution of the ADC. In the prior art image processing and compression, the digitized pixel comprising of one color component per pixel is converted to be three color components 19, R,G,B, per pixel. The RGB format then further converted to YUV format 101 for image and video compression 102.

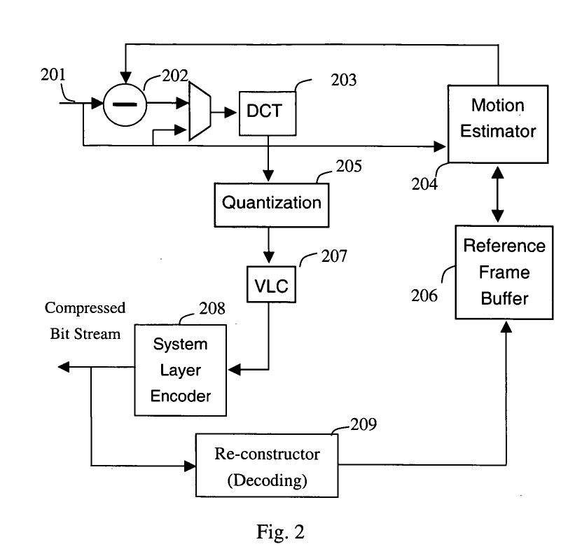

FIG. 2 illustrates the diagram and data flow of a widely used MPEG digital video compression procedure, which is commonly adopted by compression standards and system vendors. This MPEG video encoding module includes several key functional s: The predictor 202, DCT 203, the Discrete Cosine Transform, quantizer 205, VLC encoder 207, Variable Length encoding, motion estimator 204, reference frame buffer 206 and the re-constructor (decoding) 209. The MPEG video compression specifies I-frame, P-frame and B-frame encoding. MPEG also allows macro- as a compression unit to determine which type of the three encoding means for the target macro-. In the case of I-frame or I-type macro encoding, the MUX selects the coming pixels 201 to go to the DCT 203, the Discrete Cosine Transform, the module converts the time domain data into frequency domain coefficient. A quantization step 205 filters out some AC coefficients farer from the DC corner which do not dominate much of the information. The quantized DCT coefficients are packed as pairs of “Run-Level” code, which patterns will be counted and be assigned code with variable length by the VLC Encoder 207. The assignment of the variable length encoding depends on the probability of pattern occurrence. The compressed I-type or P-type bit stream will then be reconstructed by the re-constructor 209, the reverse route of compression, and will be temporarily stored in a reference frame buffer 206 for next frames' reference in the procedure of motion estimation and motion compensation. As one can see that any bit error in MPEG stream header information will cause fatal error in decoding and that tiny error in data stream will be propagated to following frames and damage the quality significantly.

A still image compression, like JPEG is similar to the I-frame coding of the MPEG video compression. An 8×8 of Y, Cr and Cb pixel data are compressed independently by going through similar procedures of the I-frame coding including DCT, quantization and a VLC coding.

The Best Match Algorithm, BMA, is the most commonly used motion estimation algorithm in the popular video compression standards like MPEG and H.26x. In most video compression systems, motion estimation consumes high computing power ranging from ˜50% to ˜80% of the total computing power for the video compression. In the search for the best match macro, for reducing the times of computing, a searching range 39 is defined according to the frame resolution, for example, in CIF (352×288 pixels per frame), +/−16 pixels in both X- and Y-axis, is most commonly defined. The mean absolute difference, MAD or sum of absolute difference, SAD as shown below, is calculated for each position of a block within the predetermined searching range, for example, a +/−16 pixels of the X-

$$\begin{matrix}\begin{matrix}SAD ( x , y ) = {\sum }_{i = 0}^{15} {\sum }_{j = 0}^{15} \vert {V}_{n} ( x + i , y + j ) - \\ {V}_{m} ( x + d x + i , y + d y + j ) \vert\end{matrix} & ( Eq . 1 ) \\ \begin{matrix}MAD ( x , y ) = \frac{1}{256} {\sum }_{i = 0}^{15} {\sum }_{j = 0}^{15} \vert {V}_{n} ( x + i , y + j ) - \\ {V}_{m} ( x + d x + i , y + d y + j ) \vert\end{matrix} & ( Eq . 2 )\end{matrix}$$

axis and Y-axis. In above MAD and SAD equations, the Vₙ and Vₘ stand for the 16×16 pixel array, i and j stand for the 16 pixels of the X-axis and Y-axis separately, while the dₓ and d_{y} are the change of position of the macro. The macro with the least MAD (or SAD) is from the BMA definition named the “Best match” macro.

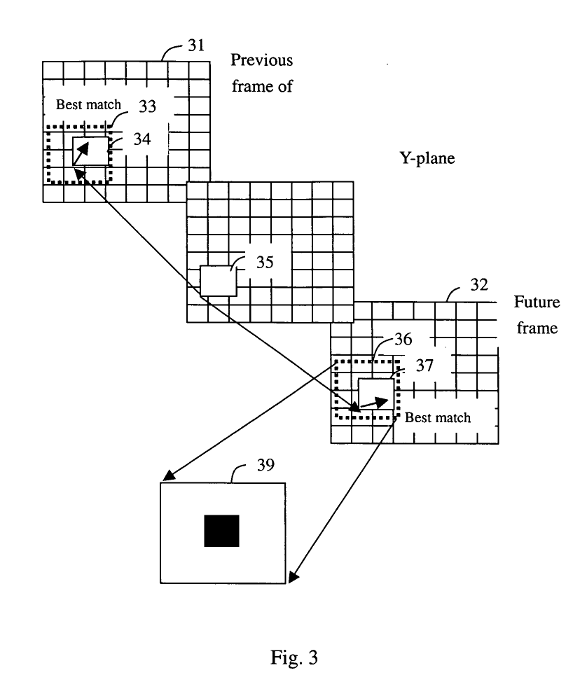

FIG. 3 depicts the best match macro searching and the depiction of the searching range. A motion estimator searches for the best match macro within a predetermined searching range 33, 36 by comparing the mean absolute difference, MAD, or sum of absolute differences, SAD. The block of a certain of position having the least MAD or SAD is identified as the “best match” block. Once the best matches are identified, the MV between the targeted block 35 and the best match's 34, 37 can then be calculated and the differences between each within a block can be coded accordingly. This kind of difference coding technique is called “Motion Compensation”. The calculation of the motion estimation consumes most computing power in most video compression systems. In P-type coding, only a previous frame 31 is used as the reference, while in B-type coding, both previous frame 31 and next frame 32 are referred.

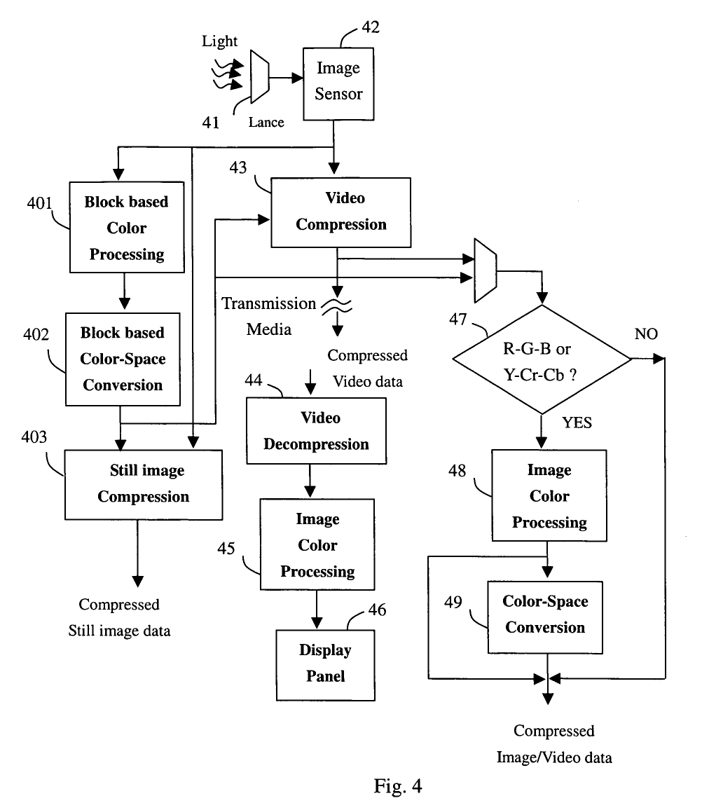

FIG. 4 illustrates this invention of the efficient image and video compression. The image sensor 42 captures the image with light shooting through a lance 41. The digitized raw data of one color component per pixel are input to the video compression 43. In the end of display, the compressed video stream will be decompressed 44 and going through the procedure of image processing 45 before presenting to the display device 46. The still image compression 403 in this invention can be done by directly compressing the digitized raw data with one color component per pixel, it can also take the YUV(YCrCb) format components which come from a color processing 401 and a color-space conversion 402 if YUV format is preferred. If the YUV/YCrCb format is preferred 47, the compressed still image or motion video output with digitized raw color component in compression can go through the color processing 48 and converted to YUV format by a color-space converter 49 before output to other devices including but not limited to memory, display or transmission.

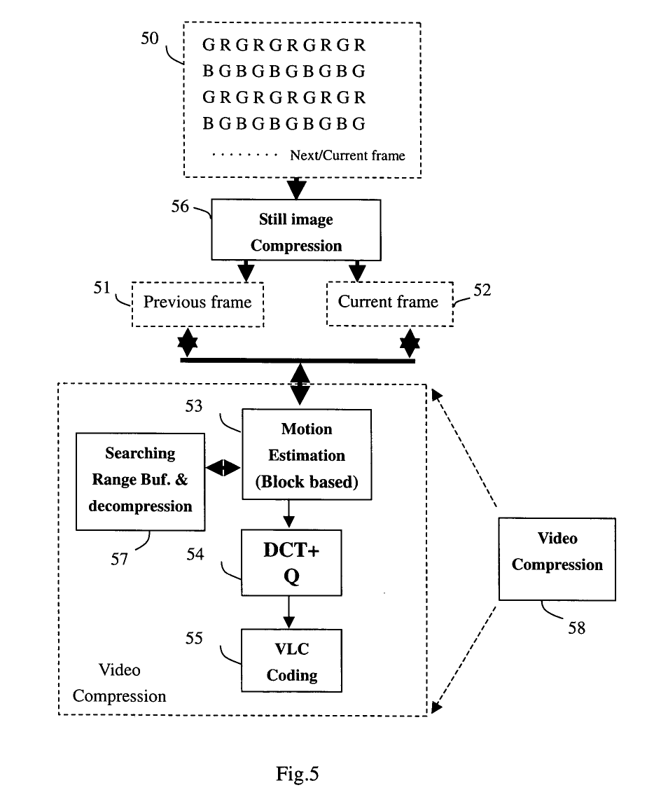

FIG. 5 shows the details of the video compression in the raw color pixel domain. The digitized raw pixels 50 with one color component per pixel are compressed 56 and saved into the temporary image buffer as a referencing “previous frame” 52. In compressing non-B-frame video sequence, the “current frame” is the one captured in the image sensor 50. When B-frame compression is determined, the “next frame” is the frame captured in the image sensor and another temporary frame buffer 51 stores the “current frame. When the time of compression is reached, the compressed pixels within the corresponding blocks will be decompressed and recovered to the raw color format for video compression. In the non-B-frame compression, the current block of pixels residing in the image sensor will be compared to blocks within the previous frame to identify the best matching block of pixels. Wherein, a predetermined searching range of pixels of the compressed previous frame pixels will be loaded to the searching range buffer and decompressed 57 block by block for the best matching block searching in motion estimation 53. The difference value of the block matching block and the current block will then calculated and gone through a procedure of DCT 54, after DCT, another step of quatization 54 will be applied to further filter out the higher frequency DCT coefficients. After quatization, a zig-zag scanning and data packing forms the data pack for a variable length coding 55 technique to apply the shorter code to represent the more frequent show up pattern hence to reduce the data rate. The MPEG and H.26x video compression 58 algorithms include the basic procedures of motion estimation, DCT, quantization and the VLC coding.

The best matching algorithm (BMA) is commonly used n motion estimation. The searching of best matching block consumes high times of computing. The basic principle of best matching block includes the calculation of the SADs 63 (Eq. 1 or MADs in Eq. 2) between the current block of the current frame and the blocks of previous frame 62 or/and next frame 61. The calculation of SAD includes the three calculations 66:
1). C=Pₙ−Pₙ (pixel of current block and a block in referencing frame)
2). C=ICI
3). C=Acc.C

The calculated value of SADs are stored a register 64. The location with the minimum SAD 65 will be identified as the best matching block. In this invention of the efficient video compression, SAD calculation includes the color component within a block of pixels, it can also include the SAD of only Green components since in the color-space conversion, the Green component dominates more than 50% of the weighted factor and in most image sensor color algorithms including the popular Bayer Pattern include 50% cells of Green components.

In a derivative of this invention of a still image compression, the input of threes color components of RGB or YUV 72 per pixel data can be a selection. If a YUV is the selected format, the procedure of the color-space conversion 71 applied to convert the RGB format to the YUV format followed by the DCT 73, quantization 74 and the VLC coding 75 to come out of a compressed still image data stream. No matter the compressed data of a still image or a motion video stream compressed from the raw color format with one color component per pixel, the stream can be decompressed by a VLD, variable length decoder 78 followed by a dequantization 79 and an inverse DCT (iDCT) 701. If the format of an RGB per pixel is selected, then the output of the iDCT should go through an image color processing 76 before outputting, if an YUV format is determined, then, the RGB components should be converted to be YUV through a color-space conversion 77.

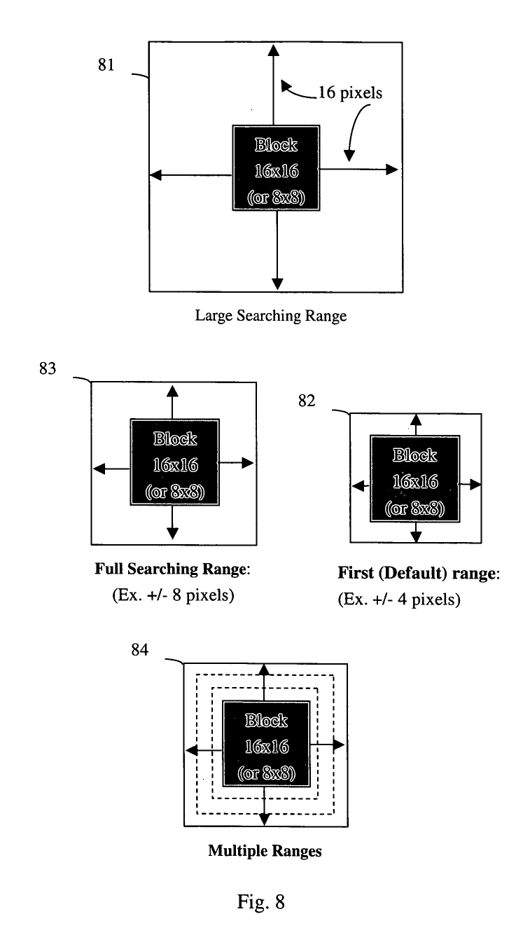

For reducing the computing times, in most motion video compression algorithms, the motion estimation searches for the best matching block within a predetermined searching range surrounding the starting point. The searching range is proportional to the resolution of the frame, which means the larger a frame, the larger range will be predetermined for the motion estimation. For instance, in the MPEG video compression, the CIF (352×288 pixels) resolution frame adopts a block size of 16×16 pixels as the unit of motion estimation coupled with a searching range of +/−16 pixels in X-axis and another +/−16 pixels in Y-axis 81 as shown in FIG. 8. A searching range image buffer is to temporarily store the searching range of pixels for the best matching block searching. This invention of the efficient video compression determines a smaller searching range compared to most MPEG video recommends said +/−16 pixels in X- and Y-axis. When the current block is searching for the best matching block another step of the starting point prediction is running in parallel. To avoid waiting and to reduce power consumption, in this invention of the efficient video compression, a first range 82 of pixels surrounding the predicted starting point are allocating from the referencing frame buffer to the searching range buffer for the next block motion estimation. If the predicted starting point of the next block is beyond a threshold value, said (+/−4 pixels), then, the whole searching range 83 of pixels will be filled by further moving pixels from the referencing frame buffer. Dividing the searching range of pixels into multiple ranges 84 can further save the time of allocating pixels from the referencing frame buffer to the searching range pixel buffer coupled with multiple threshold value of the predicted starting point. For more accurately predicting and allocating pixels from the referencing frame to the searching range buffer, a couple of factors are applied including comparing the SADs/MADs of neighboring blocks and the block with the same location in more than one previous frame. Practically, the first range of pixels for the searching range pixel allocation is no more than three quarters of the full searching range of pixels, and the second range of searching range is no more than one quarter of the total searching range.

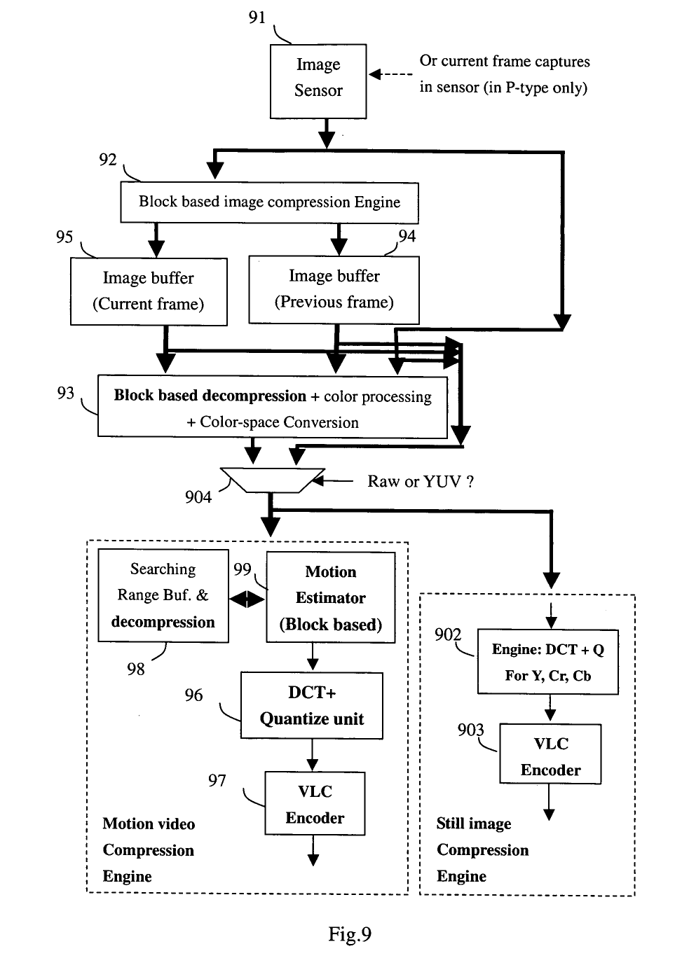

FIG. 9 shows the block diagram of the implementation of a device for this invention of the efficient video compression. An image sensor 91 captures a frame of image block by block with digitized format of one color component per pixel. An image compression unit 93 reduces the data rate of the digitized color component and temporarily saves them into the referencing memory buffer including the previous frame buffer 94 and the current frame 95 image buffers. In non-B-frame coding, the current frame resides in the image sensor array, while in the B-frame coding, the frame captured in the image sensor is the next frame. For efficiency, a larger amount of pixel per “Block” for example, 64×64 pixels per “Block” will be applied in the still image compression 91 of the raw color pixels.

In motion video compression, a motion estimator 99, searching for the best matching block, is connected to a temporary image buffer for saving the current block of current frame and a searching range buffer 98 with an image decompression engine to recover the pixels of the searching range in the previous or in next frame. The difference between the current block of the present frame and previous or/and next frame are sent to the DCT and quantization unit 96, the quantized DCT coefficients will then sent to the variable length, VLC encoder 97. In still image compression, the block pixels with selected pixel format are input to the DCT and quantization engine 902, and a VLC encoder 903 is implemented to reduce the data rate.

This invention of efficient image and video compression is done by adopting the digitized raw color components with one color component per pixel. Nevertheless, with similar principle, it accepts other alternatives of variable pixel formats. For example, if the YUV/YCrCb format 904 is selected for the video or/and image compression, then an engine will block by block decompress 93 the compressed frame of pixels and functions the color processing and the color-space conversion 93 to output the pixel with YUV/YCrCb format for image and/or video compression.

All above operation of this invention of the efficient video and image compression can be done by using firmware which controls a DSP hardware. And a CPU can be implemented together with the DSP for controlling the data flow of the whole image and video compression.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of capturing, compressing and manipulating the digital video, comprising:
sequentially digitizing the image captured in the image sensor and transferring the digitized pixel data with one color component per pixel to a temporary image buffer;
compressing the digitized video sequence by coding intra-frame pixel information or inter-frame of the differences between the current frame and at least one of the neighboring frames; and
before presenting the video to a display device, decompressing the compressed video data and going through the procedure of image color processing to meet the format of display device and to optimize the quality for the display device.

2. The method of claim 1, wherein an analog-to-digital convert circuit is applied to transform the captured image signal in the image sensor cell into digital format with one color representation per pixel.

3. The method of claim 1, wherein the video compression procedure is done by manipulating the digitized pixel data in the format of one color component per pixel;

4. The method of claim 1, wherein the temporary buffer is comprised of storage device having a density of at least one frame pixels;

5. The method of claim 4, wherein the referencing frames of pixels include a previous frame and a current frame if B-type coding is selected, or only a previous frame if non-B-type coding is selected.

6. The method of claim 1, wherein the length of bits to represent the digitized image pixels is fixed or programmable according to the resolution of the targeted display device.

7. The method of claim 6, wherein if the length of bits to represent the digitized image pixels is fixed, in the final stage of color processing before displaying, the LSB bits are truncated according to the format of the display device.

8. The method of claim 1, wherein the compressed video data stream is decompressed before display by the reversed procedure of video compression of this method of invention.

9. A method of the video compression, comprising:
motion estimation with the best matching searching algorithm by calculating the block movement with the digitized color component data for each pixel within a block;
intra-frame or inter-frame coding decision making;
if intra-frame coding is selected, then applying a technique of the spatial redundancy removal;
if inter-frame coding is selected, then applying a technique of temporal redundancy removal: by calculating and coding the differences by between the targeted frame and at least one of the neighboring frames; and
applying the procedure of the DCT, quantization and a variable length coding alternative to reduce the data rate in either intra-frame or inter-frame coding.

10. The method of claim 9, wherein if no B-type coding is selected between P-type or I-type frames, then, only one previous frame of pixels is stored as the referencing frame for the motion estimation, and the targeted current frame is the frame captured in the image sensor.

11. The method of claim 9, wherein if B-type coding is selected then, two frames pixels are stored as referencing frames with the previous frame saving in a RAM memory and the next frame is the one captured in the image sensor and the current frame is stored in another RAM memory.

12. The method of claim 9, wherein the SAD or MAD value is generated by calculating the accumulated difference between the digitized color components of block pixels within current frame and those of the referencing frame buffer.

13. The method of claim 9, wherein the SAD or MAD value is generated by calculating the accumulated difference between the digitized Green components of pixels within current frame and those of the referencing frame buffer.

14. A method of allocating image data from the referencing frame to the searching range pixel buffer for motion estimation, comprising:
searching for the best matching of the current from at least one of the neighboring frames;
predicting the starting point of the next block of best matching searching in motion estimation;
moving the first range of pixels surrounding the predicted starting point of the next block of the referencing frame buffer to the searching range pixel buffer; and
if the predicted displacement is beyond a predetermined threshold value, then, moving the second range of pixels surrounding the predicted starting point of the next block of the frame buffer to the searching range pixel buffer;

15. The method of claim 14, wherein the first range of pixels to be moved from the referencing frame buffer to the searching range buffer includes no more than three quarters of the total searching range pixels.

16. The method of claim 14, wherein the threshold value of the displacement used to decide whether to move the second range of pixels to the searching range buffer is dependent on the displacement values of the predicted starting point of the next block of the referencing frame buffer.

17. The method of claim 14, wherein if the minimum SAD or MAD value within the searching range of the current block is beyond a threshold value, then, an I-type coding algorithm is enforced.

18. The method of claim 17, wherein multiple ranges of pixel moving with multiple threshold values of displacement is applied to determine the pixels amount to be moved from the referencing frame buffer to the searching range buffer.

19. The method of claim 14, wherein the referencing frame buffer can be an off-chip DRAM memory or an on-chip SRAM memory.

20. An apparatus of video compression achieving high efficiency with low requirements of the image buffer density, I/O bandwidth and power consumption, comprising
an image sensor capturing the light and digitizing the pixel data;
a first block based image compression unit to reduce the data rate of the digitized image pixels and to save into the temporary frame buffer;
a referencing frame buffer storing at least one frame of pixels;
a block based decompression, color processing and color-space-conversion unit which recovers and produces pixels with YCrCb format for the operation of still image compression or motion video compression should YCrCb format is determined in compression; and
a second compression engine for reducing the data rate of the captured images directly from the image sensor or from the decompression unit which recovers the image from the temporary image buffer;

21. The apparatus of claim 20, wherein the second compression engine is a motion video compression engine to compress the video sequence frames.

22. The apparatus of claim 20, wherein the second compression engine is a still image compression engine to compress the captured image in the image sensor.

23. The apparatus of claim 20, wherein the referencing frame buffer stores at least one previous frame is made of on-chip SRAM or off-chip DRAM.

24. The apparatus of claim 20, wherein the decompression unit recovers the pixel data of the searching range within the referencing frame and saves into the searching range buffer for the best matching calculation in the motion estimation.

25. The apparatus of claim 20, wherein the engine with block based decompression, color processing and a color-space conversion operates for recovering raw pixel data, color processing of each pixel and converting the RGB to YCrCb format to fit the resolution and pixel format if YCrCb format is predetermined for the still image or motion video compression.

26. The apparatus of claim 20, wherein if the user decides to select the output with image format of one color per pixel, the block based color processing unit is bypassed and the still image or motion video compression engine directly receives the digitized raw pixel data and compresses them with the format of one color component per pixel.

27. The apparatus of claim 20, wherein the motion estimator searches for the best matching by calculating the SAD or MAD values of the digitized image data with one color component per pixel.

28. The apparatus of claim 20, wherein a DSP engine is integrated with the image sensor on the same semiconductor die to function as the compression and decompression engine as well as the color processing and color-space conversion functions.

29. The apparatus of claim 20, wherein a CPU is integrated with the image sensor on the same semiconductor die to controller the data flow of the whole system of the video compression, decompression and display.
